(19) United States
(12) Patent Application Publication
(10) Pub. No.: US 2004/0004522 A1
(43) Pub. Date: Jan. 8, 2004

(54) N-way signal divider

(76) Inventors: Anthony C. Sweeney, Salem, NH (US); Thomas M. Gaudette, Boston, MA (US)

Correspondence Address: KOLISCH HARTWELL, P.C., 520 S.W. YAMHILL STREET, SUITE 200, PORTLAND, OR, 97204, US

(21) Appl. No.: 10/613,882

(22) Filed: Jul. 2, 2003

Related U.S. Application Data
(60) Provisional application No. 60/394,067, filed on Jul. 3, 2002.

(51) Int. Cl. H01P 5/12

(52) U.S. Cl. 333/127

(57) ABSTRACT

The disclosed example of an N-way RF divider has a first conductor that directs RF energy through a body to a common node of a planar conductive pattern of equiangularly spaced, radially extending arms of equal length. Secondary conductors extend orthogonally to the planar pattern through corresponding passages from the ends of the radial arms. The secondary conductors may extend parallel to and circumferentially spaced from the first conductor. Resistors may connect adjacent ends of the secondary conductors opposite from the planar conductive pattern.

### CROSS-REFERENCE TO RELATED APPLICATIONS

This application claims priority based on, and incorporates by reference, U.S. Provisional Application No. 60/394,067 filed Jul. 3, 2002.

### BACKGROUND OF THE INVENTION

1. Field of the Invention

This invention generally relates to radio frequency (RF) circuits and more specifically to an RF signal divider. The term divider refers to a device that divides a signal into a plurality of signals, as well as a device that combines a plurality of signals into a combined signal.

2. Description of Related Art

Signal dividers and combiners are used for different functions in RF applications, such as for amplifying a high power signal by amplifying each of a plurality of lower power signals. In such applications, the signal may be divided, amplified and then recombined. For example, a received signal from an antenna or low-level RF transmitter may be amplified in a preamplifier stage and then split and fed through multiple parallel power amplifiers to be recombined as a higher power RF output signal. As a further example, a 600-watt transmitting facility may include four 150-watt transmitters operating in parallel, rather than a single 600-watt transmitter. Using lower powered amplifiers provides reliability through redundancy and may reduce costs, since several lower powered RF amplifiers may cost less than a single high-powered amplifier. Moreover, the use of lower powered amplifiers allows different sites to be configured at different power levels without requiring different amplifiers. For example, a single amplifier could be used to provide a 150-watt transmitting facility, and two amplifiers could be used to provide a 300-watt transmitting facility.

Many different configurations of signal dividers and combiners have been devised. Examples are disclosed in the following patent references, which references are incorporated by reference: U.S. Pat. Nos. 4,463,326; 5,872,491; 3,091,743; 4,163,955; 4,234,854; 4,263,568; 3,582,813; 4,272,740; 5,142,253; 6,121,853; 4,947,143; 5,872,491; 4,189,684; 4,588,963; 4,470,021; 4,453,139; 6,545,564; 5,880,648; and International Publication No. WO 01/61780 A1. These configurations compensate for impedance changes between ports on the combiners and dividers. Many configurations tend to be relatively complex and expensive to manufacture.

### SUMMARY

An N-way RF divider divides a signal path into N signal paths. The divider may include a plurality of parallel transmission lines. In some embodiments, a first transmission line and a plurality of second transmission lines extend between first and second opposite ends of a body. An end of the first transmission line is connected to an end of each of the second transmission lines. In some embodiments, the connection between the ends of the first and second transmission lines may be in the form of a planar conductive pattern. In some embodiments, the conductive pattern includes a common node connected to the first transmission line and a plurality of equiangularly spaced arms of equal length extending radially from the common node to ends of the second transmission lines.

### BRIEF DESCRIPTION OF THE DRAWINGS

FIG. 1 is a perspective view of an RF divider.

FIG. 2 is an exploded view of the major elements of the RF divider shown in FIG. 1 from a first viewing point.

FIG. 3 is an exploded view of the major elements in the RF divider shown in FIG. 1 from a second viewing point.

FIG. 4 is a longitudinal cross section of the RF divider of FIG. 1.

FIG. 5 is a lateral cross section taken along line 5-5 in FIG. 4.

FIG. 6 is an end view of the RF divider of FIG. 4 as viewed from the right in FIG. 4.

FIG. 7 is an end view of the RF divider of FIG. 4 as viewed from the left in FIG. 4.

### DETAILED DESCRIPTION

An N-way divider is disclosed in which a first transmission line is connected to N second transmission lines, where N is an integer greater than one. As an example, FIGS. 1 through 7 disclose an N-way divider 10 in which N=3. Thus, as illustrated, divider 10 may also be referred to as a three-way divider. N may have other integral values, such as 2, 4 and 7. The RF divider 10 includes a body 12 that extends along an axis 14. Typically, the body 12 will be machined from copper. Other electrically conductive materials may be used, or as will be discussed further below, a dielectric material may be used. For convenience of manufacture, body 12 may have a cylindrical shape, allowing it to be manufactured on a high-speed screw machine center. Other regular or irregular body shapes may be used.

In this embodiment, body 12 includes a first, connection end 16 and an opposite, junction end 18. Connection end 16 includes an outer rim 20, an annular face 22 that is recessed from the rim and orthogonal to longitudinal axis 14, and a central extension 24 that extends beyond face 22 along axis 14. Junction end 18 includes an outer rim 26 and a recessed circular face 28 that is also orthogonal to axis 14. A central passage or bore 30 extends coaxially along axis 14 through the body between the extension and end 18.

Additionally, since in this example, N=3, the body also has three second bores or passages 32, including passages 32a, 32b and 32c. Passages 32 are spaced from central passage 30 at equal distances from axis 14, and are evenly circumferentially spaced around axis 14. In this example, then, the second passages are positioned at 120-degree intervals around the axis. For other values of N, the body 12 will contain N second passages. The second passages are equiangularly spaced by 360°/N.

Passages 30 and 32 are shown as round bores, as this is a convenient shape to machine. Other shapes that provide a signal path, such as a rectangular shape, may also be used.

Mounted in extension 24 in passage 30 is a single first RF port or connector 34 of a variety of commercial configurations that acts as an input RF connection. The RF connector 34 carries a first conductor 36 that passes through central passage 30. As will be apparent, the conductor 36 and the portions of the body 12 surrounding the passage 30 constitute a coaxial RF signal path, shown generally at 38, in the form of a transmission line 40. One transmission line end 40(1) is connected to connector 34 and another end 40(2) corresponds with body second end 18. The portion of the body forming passage 30, identified as an outer conductor 42, functions as a signal-return conductor. It will be appreciated that other forms of conductor 42 may be provided, such as a separate electrically conductive sleeve or tube supported in an electrically conductive or dielectric body.

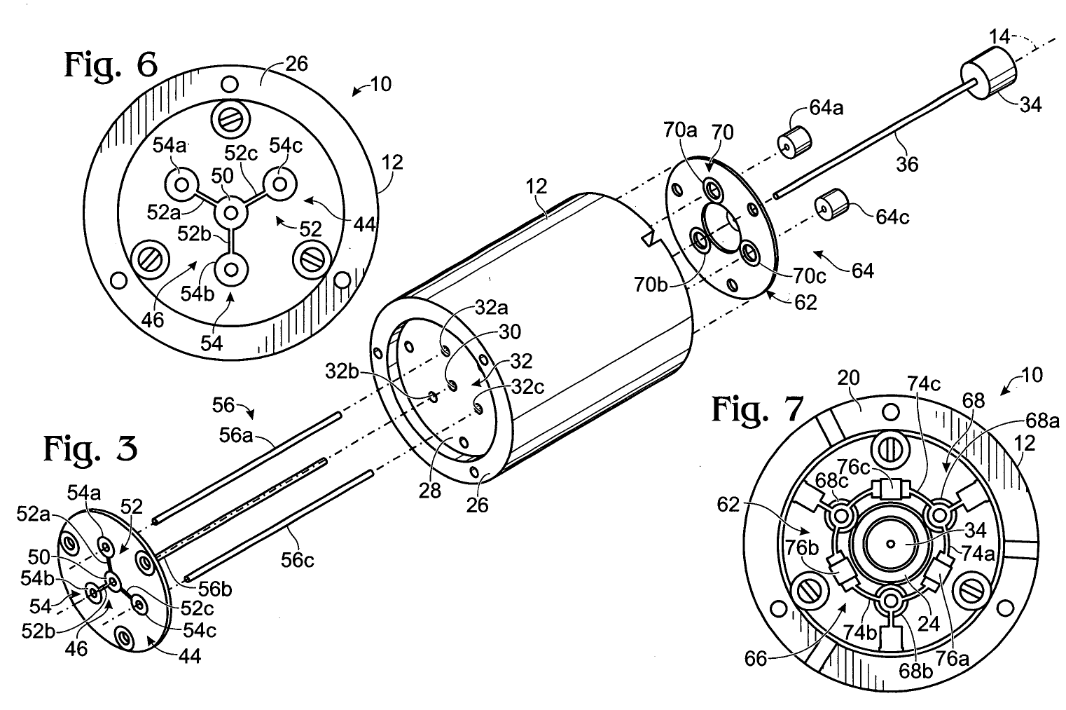

As particularly shown in FIGS. 3, 4 and 6, a connection printed circuit board (PCB) 44 is mounted on recessed face 28 on body end 18. On PCB 44 is a conductive pattern 46. Pattern 46 divides signal path 38 into N signal paths 48. In this example, second or divisional signal paths 48a, 48b and 48c are provided. Although other conductive pattern configurations may be used, for convenience of manufacture and improved circuit performance, the conductive pattern is planar and includes a central, common node 50, aligned with central passage 30 for contact with center signal conductor 36. Conductive pattern 46 also includes N equally angularly spaced arms 52 of equal length radiating from the common node 50 to end portions, including arms 52a, 52b and 52c. Pattern 46 includes three arms because N=3 in this specific embodiment. The number of arms corresponds to the value of N and the angular spacing is 360°/N. Arms 52a, 52b and 52c extend radially to distal end portions or nodes 54, including respective nodes 54a, 54b and 54c. Nodes 54 are positioned in alignment with corresponding second passages 32.

Extending from PCB 44 are N second signal conductors 56 that extend the length of passages 32, including conductors 56a, 56b, and 56c extending through respective passages 32a, 32b and 32c. Conductors 56 extend orthogonally to the plane of PCB 44 and conductive pattern 46. Passages 32 form continuations of signal paths 48, and the portion of body 12 forming the passages 32, identified as outer conductors 58, function as signal-return conductors 58a, 58b and 58c. Signal conductors 56 and associated outer conductors 58 form respective transmission lines 60, including transmission lines 60a, 60b and 60c, extending from one end 60(1) at common node 50 of the conductive pattern to another end 60(2) at the connection end 16 of body 12. Signal paths 48 correspond to transmission lines 60.

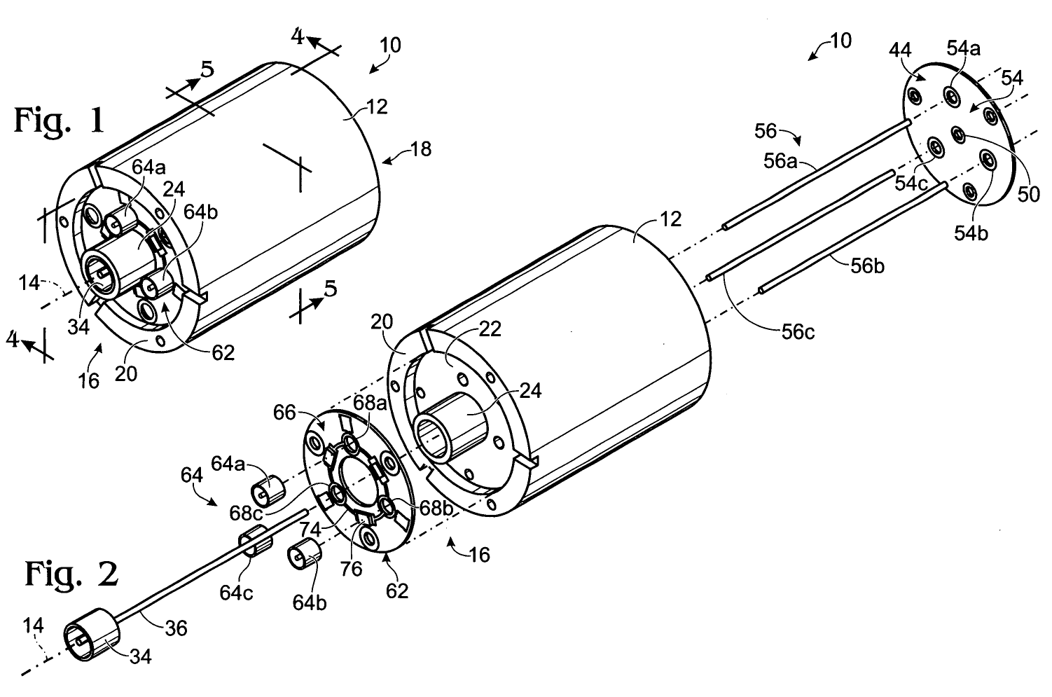

An output isolation printed circuit board (PCB) 62 is mounted on recessed face 22 of first end 16 of body 12, as particularly shown In FIGS. 2, 4 and 7. PCB 62 carries second RF ports or connectors 64, Including connectors 64a, 64b and 64c that connect an external circuit to respective transmission lines 60a, 60b and 60c. Connectors 64 serve as RF output connections and are aligned with each of the passages 32.

PCB 62 has a planar conductive pattern 66 that includes N nodes 68 connected to signal conductors 68 by corresponding plated vias or through holes 70. More specifically, nodes 68a, 68b and 68c are connected to respective signal conductors 56a, 56b and 56c by through holes 70a, 70b and 70c. Each plated through hole 70 connects to a second RF connector 64. Conductive pattern 66 Includes conductors 74 that connect Isolation resistors 76 between each pair of nodes 68. In particular, conductors 74a, 74b and 74c connect resistors 76a, 76b and 76c to respective pairs of nodes 68a and 68b, 68b and 68c , and 68c and 68a. An N-way divider contains N resistors. These resistors 76 provide Isolation between the RP output signals, and typically have a value of N×3₀, where 3₀ is the characteristic inpedance of the input connection.

An input signal is conveyed from the first input connection port 34 through the first RF path 38, including the center conductor 36 that extends to the common node 50 on Junction PCB 44. From the common node 50, the Input signal distributes back through the second RF paths 48 that include arms 52 and second conductors 56, to the output connectors 64.

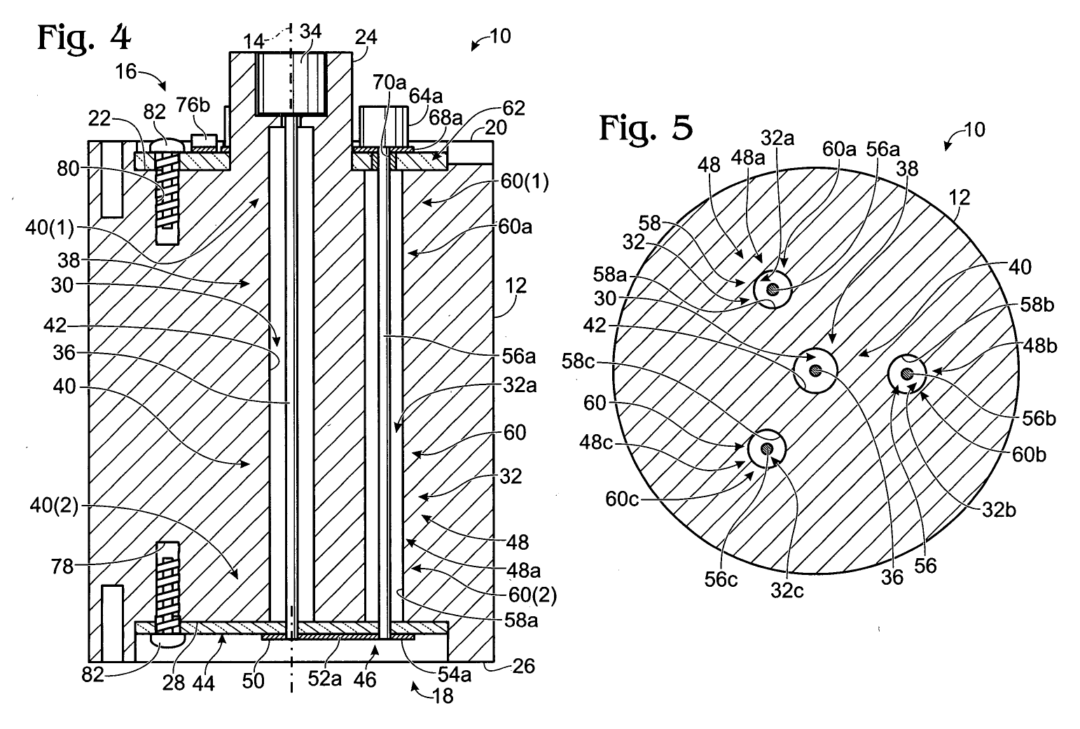

The RF divider, as illustrated, includes some fasteners for affixing the junction and isolation circuit boards 44 and 62 to the body 12. For example, FIG. 4 depicts machined tapped holes 78 and 80 that receive machine screws 82 to fasten the circuit boards 44 and 62 on their respective faces 22 and 28.

In a specific implementation for a specific value of N and a specific value of frequency, the length of each of the conductors 56 and the outer conductors 58 are selected so the conductive path from the common node 50 to each RF output connection, such as RF output connectors 64, has a length of one-fourth of the wavelength. Likewise the conductor 36 and outer conductor 42 have corresponding lengths. These lengths then control the length of the body 12 along the axis 14. As known, the impedance of a coaxial conductive path can be controlled by the spacing between a center conductor and a shielding conductor. Thus, the shape and size of the first conductor 36 and passage 30 defines the spacing between the outer conductor 42 and the surface of the center conductor 36 to provide an impedance match between the RF input connector 34 and the impedance at the common node 50. The same holds true for the second signal paths 48 in passages 32.

The RF divider 10 is readily scaled in frequency and readily adapted for different values of N. Scaling the device to different frequencies is obtained by changing the dimensions of the RF divider, including the lengths of the conductors 36 and 56 and the length of the body 12 along the axis 14. That is, for higher frequencies the overall length of the RF divider 10 is reduced. For different values of N, the body 12 is machined with N secondary passages at an angular spacing of 360°/N. In addition, as the number of arms 52 increases, the impedance of common node 50 decreases. However, it is merely necessary to vary the diameter of the center passage 30, the diameter of the center conductor 36 or both to effect the appropriate impedance transformation between the first RF connector 34 and the common node 50.

Thus, the structure of the RF divider 10 allows an RF designer to select the number of passages and impedance transformation for different values of N and to select the length of the RF divider 10 for different frequencies. These are independent variables. Therefore the RF divider is readily scalable in frequency and readily adapted for different values of N.

It has been found a device for a given frequency provides isolation at greater than −33 dB. Useful frequency bands of ±8% have also been observed. Thus, the isolation of this RF divider is improved over conventional Wilkinson dividers and the bandwidth for a given implementation is improved.

Although a specific configuration of a cylindrical body 12 and circular circuit boards 44 and 62 is disclosed, other configurations can be substituted. The body 12 has been disclosed as being formed of copper. As has been discussed, other conductive materials might be used for different applications, and the use of dielectric materials with electrically conductive outer conductors surrounding the passages can be used. Other shapes of body 12 may be used. Additionally, conductive arms 52 in conductive pattern 46 can be shortened and common node 50 enlarged correspondingly. This would change the lengths of the passages compared to the design depicted. Additionally, the first and second transmission lines may extend along different lengths of the body, and the body may be formed of segments of a plurality of body segments. The conductive patterns are shown as circuit boards that are orthogonal to the passages. Other, non-planar configurations may also be used, such as conical or other symmetrical shapes.

### Industrial Applicability

RF signal dividers, including combiners, described in the present disclosure are applicable to the telecommunications and other radio frequency signal processing industries in which a signal path is divided or combined.

It is believed that the disclosure set forth above encompasses multiple distinct disclosures with independent utility. While each of these disclosures has been disclosed in its preferred form, the specific examples thereof as disclosed and illustrated herein are not to be considered in a limiting sense as numerous variations are possible. The subject matter of the disclosures includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that correspond to disclosed examples and are novel and non-obvious. Other combinations and subcombinations of features, functions, elements and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present disclosure.

What is claimed is:

1. An N-way RF divider comprising:
a body extending along a longitudinal axis and having first and second ends;
a first transmission line extending between the first and second ends of the body;
N second transmission lines extending between the first and second ends of the body; and
an electrical connection between a first end of the first transmission line and a first end of each of the second transmission lines.

2. The N-way RF divider of claim 1, of which the electrical connection includes a conductor extending from a first end of the first transmission line to a first end of each of the second transmission lines, and the length of the first transmission line is equal to the combined length of a second transmission line and the associated conductor.

3. The N-way RF divider of claim 1, of which the first transmission line is longer than each of the N second transmission lines.

4. The N-way RF divider of claim 3, of which a first end of the first transmission line is coplanar with a first end of each of the second transmission lines, and a second end of the first transmission line extends beyond a second end of each of the second transmission lines.

5. The N-way RF divider of claim 1, further including a plate mounted on the second end of the body, and a plurality of resistive paths mounted on the plate, the resistive paths interconnecting each pair of second ends of the second transmission lines.

6. The N-way RF divider of claim 1, of which the body is electrically conductive and forms a conductor of each of the first and second transmission lines.

7. An N-way RF divider comprising:
a first connection;
N second connections;
a planar conductive pattern;
a first signal path between the first connection and the planar conductive pattern, the first signal path being orthogonal to the plane of the conductive pattern;
N second signal paths between the conductive pattern and respective second connections, each second signal path extending orthogonally to the plane of the conductive pattern; and
N resistors lying in a plane parallel to the plane of the conductive pattern, each resistor being connected between two of said second connections.

8. The N-way RF divider of claim 7, of which the conductive pattern has a common node and N equiangularly spaced arms of equal length extending radially from the common node to end portions, and the length of the first signal path is equal to the combined length of a second signal path and the associated arm.

9. The N-way RF divider of claim 7, further comprising a body, and the first signal path extends between opposite ends of the body, and a portion of each of the second signal paths passes through the body.

10. The N-way RF divider of claim 9, of which the length of the first signal path in the body is longer than the lengths of the second signal paths in the body.

11. The N-way RF divider of claim 8, of which a first end of the first signal path is coplanar with a first end of each of the second signal paths, and a second end of the first signal path extends beyond a second end of each of the second signal paths.

12. The N-way RF divider of claim 7, further including a plate mounted on the second end of the body and a plurality of resistive paths mounted on the plate, the resistive paths interconnecting each pair of second ends of the second signal path.

13. An N-way RF divider comprising:
an electrically conductive, cylindrical body extending along a longitudinal axis and having first and second body ends, an axial extension and an annular face recessed from the extension on the first body end, and a planar face on the second body end, a first bore extending coaxially along the longitudinal axis between the first and second body ends, the first bore extending through at least a portion of the extension, and N second bores extending parallel to and spaced from the first bore, the second bores being equally circumferentially distributed about the longitudinal axis;
a first signal conductor supported centrally in and extending through the first bore, the first bore and first signal conductor forming a first transmission line extending between the first and second ends of the body;
N second signal conductors, one second signal conductor supported in and extending through each of the second bores from a first end positioned at the first body end and a second end positioned at the second body end, the second bores and second signal conductors forming N second transmission lines extending between the first and second ends of the body;
a planar conductive pattern orthogonal to the longitudinal axis and mounted on the planar face of the second body end, having a common node connected to an end of the first signal conductor, and N equiangularly spaced arms of equal length extending radially from the common node to respective end portions, each end portion being connected to a respective first end of the N second signal conductors; and
N resistors mounted in a planar configuration on the annular face of the first body end in a plane parallel to the plane of the conductive pattern, the resistors being connected to respective second ends of the N second signal conductors in a configuration forming a resistive path between each pair of second ends of the N second signal conductors.
